(19) United States
(12) Patent Application Publication
(10) Pub. No.: US 2024/0239150 A1
(43) Pub. Date: Jul. 18, 2024

(54) TECHNIQUES FOR DETECTING AND RESPONDING TO INTERNAL AUTONOMOUS VEHICLE THERMAL EVENTS

(71) Applicant: GM Cruise Holdings LLC, San Francisco, CA (US)

(72) Inventors: Domenico Rusciano, Concord, CA (US); Jeffrey Brandon, Phoenix, AZ (US)

(73) Assignee: GM Cruise Holdings LLC, San Francisco, CA (US)

(21) Appl. No.: 18/153,453

(22) Filed: Jan. 12, 2023

(51) Int. Cl. B60H 1/00; G06T 7/00

(52) U.S. Cl. CPC B60H 1/00735; G06T 7/0002; B60W 60/001

(57) ABSTRACT

A method is described and includes determining an opacity level of air inside a vehicle using at least one sensor disposed inside a cabin of the vehicle; comparing the determined opacity level with a threshold opacity level, wherein when the determined opacity level exceeds the threshold opacity level, an internal thermal event is deemed to have occurred in connection with the vehicle; determining a severity of the internal thermal event; and initiating a response to the internal thermal event, wherein the response is based on the determined severity of the internal thermal event.

### BACKGROUND

### Technical Field

The present disclosure relates generally to autonomous vehicles (AVs) and, more specifically, to techniques for automatically detecting and responding to thermal events inside AVs.

### Introduction

An AV is a motorized vehicle that can navigate without a human driver. An exemplary AV can include various sensors, such as a camera sensor, a light detection and ranging (LIDAR) sensor, and a radio detection and ranging (RADAR) sensor, among others. The sensors collect data and measurements that the AV can use for operations such as navigation. The sensors can provide the data and measurements to an internal computing system of the AV, which can use the data and measurements to control a mechanical system of the AV, such as a vehicle propulsion system, a braking system, or a steering system. Typically, the sensors are mounted at fixed locations on the AVs.

Although at some times during operation of an AV, the AV may be transporting one or more human passengers; however, at other times, the AV may be empty or may be transporting inanimate objects or non-human (e.g., animal) beings. As such, the AV may need to automatically and without human intervention detect and possibly respond to conditions within the AV, such as a thermal event.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate AV dispatch and operations, according to some aspects of the disclosed technology;

FIGS. 2A and 2B illustrate a side view and a top view, respectively, of an example AV, according to some aspects of the disclosed technology;

FIG. 3 illustrates a flowchart of example operations for detecting and responding to internal AV thermal events, according to some aspects of the disclosed technology;

FIG. 4 is a graph illustrating an example technique for classifying a severity of a detected thermal event, according to some aspects of the disclosed technology; and

FIG. 5 illustrates an example processor-based system for use in implementing some aspects of the disclosed technology.

### DETAILED DESCRIPTION

### Overview

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Given the numerous advantages of ride hail, rideshare, and delivery services (which services may be collectively and/or interchangeably referred to herein simply as “rideshare services” whether for a single user/passenger, multiple users/passengers, and/or one or more items for delivery) provided by AVs, it is anticipated that AV rideshare services will soon become the ubiquitous choice for various user transportation and delivery needs, including but not limited to school commutes, airport transfers, long distance road trips, and grocery and restaurant deliveries, to name a few.

As AVs become more widely used for the various passenger transportation and delivery services described above, it is anticipated that thermal events may occur within the cabin of such AVs due to a variety of causes. For example, a passenger may leave behind a potentially flammable object within the AV cabin after the passenger disembarks from the AV. Alternatively, high ambient temperatures within the AV (e.g., due to high environmental temperatures in the geographic area in which the AV is operating) may result in thermal events initiated by overheating of AV components. Because AVs do not have a human driver who can quickly detect and respond to thermal events within the AV, automated techniques for detecting and responding to such events may be necessary.

As will be described in greater detail below, in certain embodiments, onboard sensors and associated perception of an AV may be used in combination with images from interior cameras to detect the occurrence and categorize the severity of a thermal event within the AV cabin. For example, an image produced by an interior camera of an AV may evaluated to determine whether an opacity level of the air, or atmosphere, within the AV cabin has exceeded a minimum threshold, which may be indicative of smoke resulting from a thermal event. In a particular embodiment, a clarity of the camera image may be evaluated and compared to a clarity threshold; failure to meet or exceed the clarity threshold is indicative of an unacceptable atmospheric opacity level that may correspond to smoke from a thermal event. In another embodiment, the camera may be directed to a light within the AV cabin. The brightness of the light (e.g., in lumens) is periodically measured and compared to a threshold; failure of the image of the light to meet or exceed the brightness threshold is also indicative of an unacceptable atmospheric opacity level that may correspond to smoke from a thermal event. In various embodiments, the AV may be a member of a fleet, in which case fleet data may also be used to serve as a baseline brightness level against which to check the brightness of the cabin light.

Additionally and/or alternatively, external sensors, such as AV cameras and/or LIDAR sensors, may be used to determine the opacity of the atmosphere external to the AV cabin as a baseline measurement for use in preventing false positive detections. For example, the cameras and/or LIDAR sensors may detect the brightness of lights such as traffic lights and compare them against a fleet baseline. Still further, the opacity of the atmosphere external to the AV could be determined using the LIDAR within the AV stack to measure return signal strength. Image processing of the AV compute may be used to compare the opacity of the air outside the AV with the air within the AV cabin to rule out false positive thermal event determinations. When the opacity of the AV cabin air exceeds the opacity of the external air by a calibrated threshold amount, a determination may be made that a thermal event has occurred within the AV cabin.

Additionally and/or alternatively, temperature sensors embedded within various components of the AV may be leveraged to ascertain a severity of a detected thermal event onboard the AV. Such sensors may be integrated as heating, ventilation, and cooling (HVAC) interior temperature sensors and/or as thermal sensors embedded within AV control modules and/or compute systems. A machine learning module within the AV compute system may be used to monitor the rate of internal temperature change of the AV modules and detected opacity changes within the cabin to flag a potential thermal incident and may be further used to characterize a severity of the detected event. For example, a small differential between the opacity of the internal and external air may indicate that opacity in the internal air is likely due to environmental conditions external to the AV (e.g., a wildfire or heavy air pollution in the vicinity of the vehicle), in which case the internal air opacity would not be detected as a thermal event. In contrast, a large differential between the opacity of the internal and external air unaccompanied by a temperature change within the cabin could indicate that a passenger is smoking, which would be detected as a moderately severe thermal event and may trigger the AV to connect to a customer advisor to instruct the passenger to extinguish the cigarette and/or could trigger HVAC controls to initiate full blower and fresh air mode of operation. A large differential between the opacity of the internal and external air accompanied by a large temperature change within the cabin is likely the result of a high severity thermal event, in response to which a more extreme response, such as a safe stop of the AV, may be triggered. Other responses to a high severity thermal event may include the perception system commanding the AV planning stack to stop the AV and to open the doors and/or windows to ventilate the cabin. Additionally, remote assistance may be invoked, allowing a remote assistant to evaluate the situation using the internal camera(s) of the AV to confirm whether there is smoke or fire within the cabin.

The following detailed description presents various descriptions of specific certain embodiments. However, the innovations described herein can be embodied in a multitude of different ways, for example, as defined and covered by the claims and/or select examples. In the following description, reference is made to the drawings, in which like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the drawings, a particular number and arrangement of structures and components are presented for illustrative purposes and any desired number or arrangement of such structures and components may be present in various embodiments. Further, the structures shown in the figures may take any suitable form or shape according to material properties, fabrication processes, and operating conditions. For convenience, if a collection of drawings designated with different letters are present (e.g., FIGS. 10A-10C), such a collection may be referred to herein without the letters (e.g., as “FIG. 10”). Similarly, if a collection of reference numerals designated with different letters are present (e.g., 110a-110e), such a collection may be referred to herein without the letters (e.g., as “110”).

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y. The terms “substantially,” “close,” “approximately,” “near,” and “about,” generally refer to being within +/−20% of a target value (e.g., within +/−5 or 10% of a target value) based on the context of a particular value as described herein or as known in the art.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

### Example AV Management System

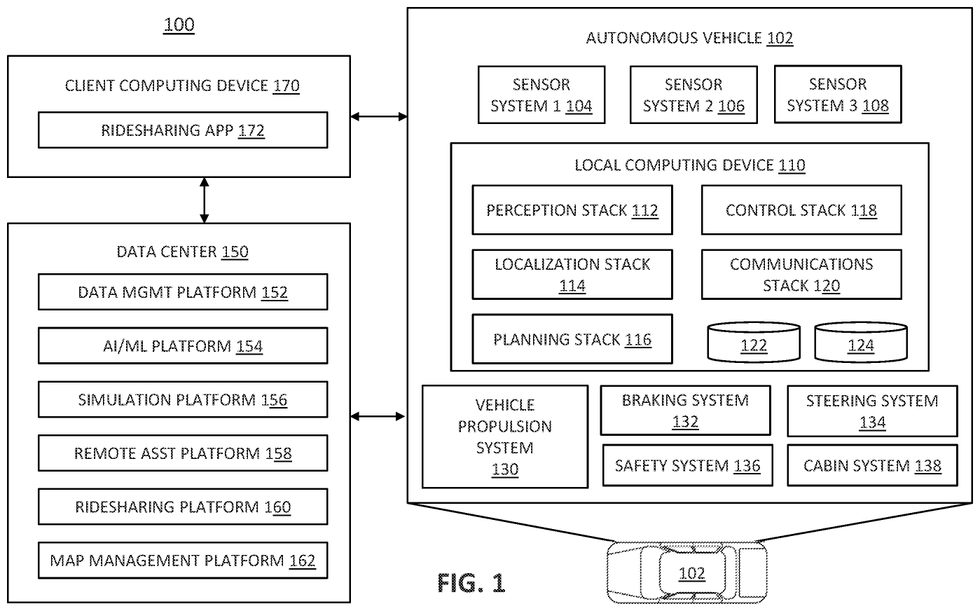

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 102 can navigate about roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors. Any of the sensor systems implemented as a camera can include light (or luminance) measurement functionality.

AV 102 can also include several mechanical systems that can be used to maneuver or operate AV 102. For instance, the mechanical systems can include vehicle propulsion system 130, braking system 132, steering system 134, safety system 136, and cabin system 138, among other systems. Vehicle propulsion system 130 can include an electric motor, an internal combustion engine, or both. The braking system 132 can include an engine brake, a wheel braking system (e.g., a disc braking system that utilizes brake pads), hydraulics, actuators, and/or any other suitable componentry configured to assist in decelerating AV 102. The steering system 134 can include suitable componentry configured to control the direction of movement of the AV 102 during navigation. Safety system 136 can include lights and signal indicators, a parking brake, airbags, and so forth. The cabin system 138 can include cabin temperature control systems, in-cabin entertainment systems, and so forth. In some embodiments, the AV 102 may not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a planning stack 116, a control stack 118, a communications stack 120, a High Definition (HD) geospatial database 122, and an AV operational database 124, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 122, other components of the AV, and other data sources (e.g., the data center 150, the client computing device 170, third-party data sources, etc.). The perception stack 112 can detect and classify objects and determine their current and predicted locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth.

Mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 122 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The planning stack 116 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 102 from one point to another. The planning stack 116 can determine multiple sets of one or more mechanical operations that the AV 102 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 116 can select from multiple backup plans to carry out. For example, while preparing to change lanes to turn right at an intersection, another vehicle may aggressively cut into the destination lane, making the lane change unsafe. The planning stack 116 could have already determined an alternative plan for such an event, and upon its occurrence, help to direct the AV 102 to go around the block instead of blocking a current lane while waiting for an opening to change lanes.

The control stack 118 can manage the operation of the vehicle propulsion system 130, the braking system 132, the steering system 134, the safety system 136, and the cabin system 138. The control stack 118 can receive sensor signals from the sensor systems 104-108 as well as communicate with other stacks or components of the local computing device 110 or a remote system (e.g., the data center 150) to effectuate operation of the AV 102. For example, the control stack 118 can implement the final path or actions from the multiple paths or actions provided by the planning stack 116. This can involve turning the routes and decisions from the planning stack 116 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 122 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

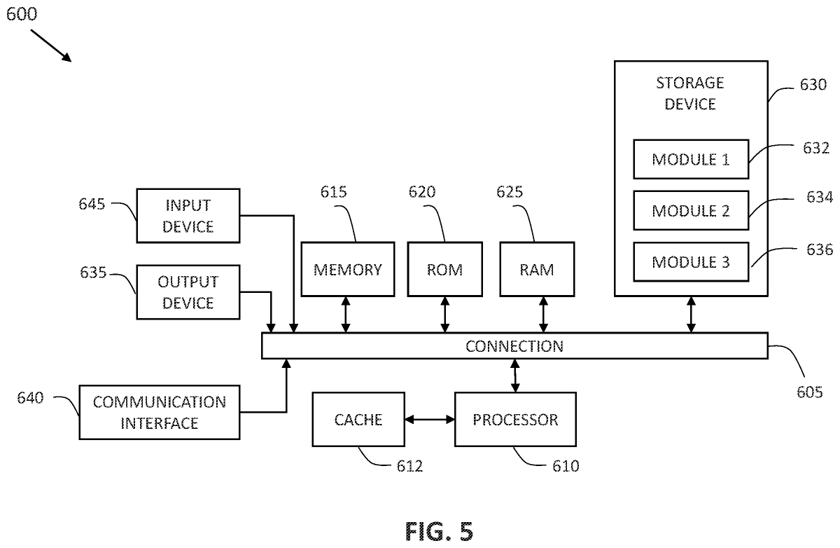

The AV operational database 124 can store raw AV data generated by the sensor systems 104-108 and other components of the AV 102 and/or data received by the AV 102 from remote systems (e.g., the data center 150, the client computing device 170, etc.). In some embodiments, the raw AV data can include HD LIDAR point cloud data, image or video data, RADAR data, GPS data, and other sensor data that the data center 150 can use for creating or updating AV geospatial data as discussed further below with respect to FIG. 5 and elsewhere in the present disclosure.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes one or more of a data management platform 152, an Artificial Intelligence/Machine Learning (AI/ML) platform 154, a simulation platform 156, a remote assistance platform 158, a ridesharing platform 160, and a map management platform 162, among other systems.

Data management platform 152 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to be picked up or dropped off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

### Example AV

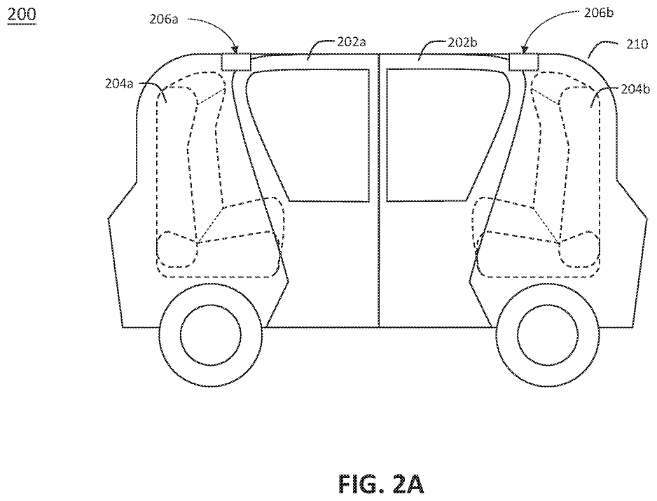

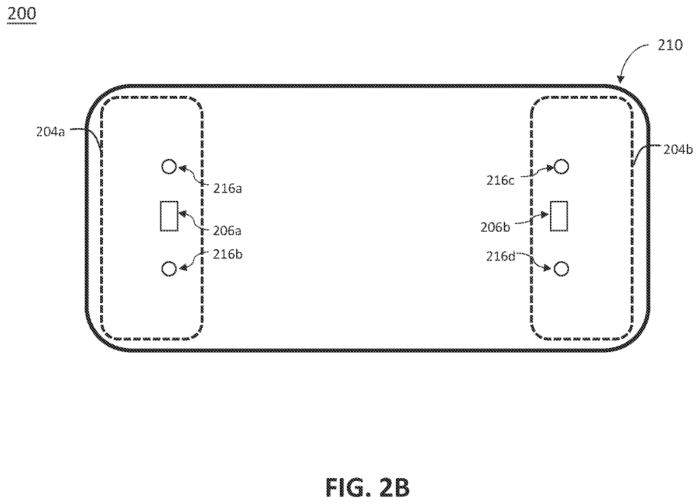

FIGS. 2A and 2B respectively illustrate a side view and a top view of an example AV 200, according to various embodiments of the disclosure. The AV 200 can be substantially similar to the AV 102 of FIG. 1. As best illustrated in FIG. 2A, the AV 200 can include doors 202a, 202b, which can slide to open rather than open outwards on a hinge. The opposite side of the AV 200 may include doors substantially identical to doors 202a, 202b. Doors 202a, 202b, can include windows that may or may not be operable to open and close. Additionally, the AV 200 includes two seats 204a, 204b facing each other within the interior cabin of the AV. The AV 200 includes interior sensors 206a, 206b, which can be substantially identical to sensor systems 104-108 of FIG. 1 and can include one or more infrared (IR) sensors, microphones, smoke detectors, carbon monoxide detectors, scent detection sensors, and neuromorphic computing chips.

Referring specifically to FIG. 2B, in particular embodiments, the AV 200 includes multiple ceiling lights, represented in FIG. 2B by lights 216a-216d. It will be recognized that additional ceiling lights may be provided and are not shown in the figures for ease of illustration. The ceiling lights 216a-216d are individual lights positioned over selected AV seats. In some examples, there are three lights over each seating area 204a, 204b, as there are three seats in each seating area 204a, 204b. In alternative embodiments, lights may be positioned in other areas within the cabin to serve the purposes described herein.

The ceiling lights 216a-416d can be red, green, blue (RGB) lights, which can be tuned to any selected color, intensity, or frequency. Additionally, the color of any of the ceiling lights can be changed and can change regularly in any selected pattern or frequency. For example, various ones of the ceiling lights 216a-216d can be turned on to selected colors at various times, such that the various ceiling lights 216a-216d can have different colors, intensities, and/or frequencies. In various examples, the color, intensity, and/or flashing frequency of the ceiling lights 216a-216d can change slowly over time or more quickly. In some examples, the ceiling lights 216a-216d are visible from outside the AV 200. In other examples, the light emitted from the ceiling lights 216a-216d is visible from outside the AV 200, e.g., through the AV windows.

In accordance with features of embodiments described herein, and for purposes that will be described in greater detail below, at least one of sensors 206a, 206b, includes a light meter for measuring a brightness, or luminance, of one or more of ceiling lights 216a-216d. In some embodiments, the light meter may be implemented as part of a camera.

### Example Techniques for Detecting and Responding to Internal AV Thermal Event

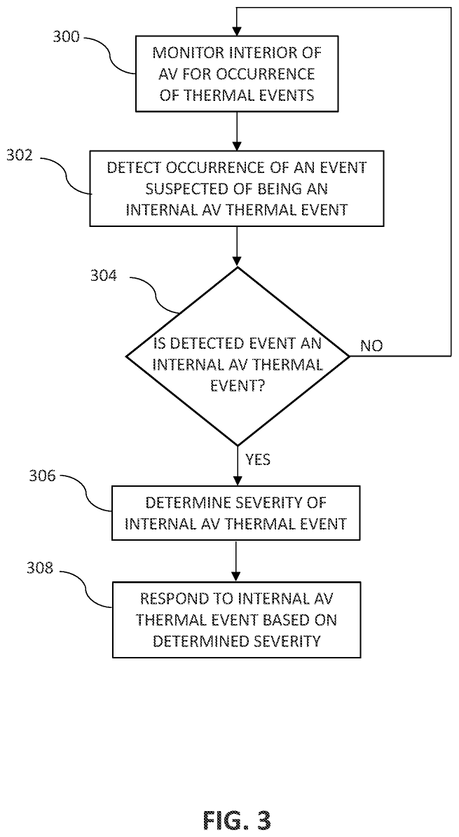

FIG. 3 illustrates a flowchart of example operations for detecting and responding to internal AV thermal events, according to some aspects of the disclosed technology. In certain embodiments, one or more of the operations illustrated in FIG. 3 may be executed by one or more of the elements shown in FIG. 1.

At operation 300, the interior cabin of an AV is monitored to detect occurrence of a thermal event. It will be recognized that the monitoring can be performed periodically (e.g., once per minute) during operation of the AV or can be triggered by occurrence of a particular event (e.g., initiation or termination of a ride or delivery service).

At operation 302, an event comprising a possible internal AV thermal event is detected. Such detection may be accomplished by determining that the opacity of the air within the cabin of the AV has met or exceeded a threshold opacity level. It will be recognized that, alternatively, such detection may be accomplished by determining that the transparency of the air within the cabin of the AV has met or fallen below a threshold transparency level. For the sake of simplicity, operations will be described with reference to opacity; however, it will be recognized that operations may also be performed using transparency values instead. In one embodiment, the opacity of the air inside the cabin of the AV may be determined by measuring the luminance of one of the cabin lights using one if the interior cameras and comparing the measured luminance to a threshold value. Alternatively, the opacity inside the cabin of the AV may be determined by evaluating in substantially real-time the clarity, or sharpness, of an image captured by the camera of a designated object within the AV cabin. In the former case, the luminance of the light as measured by the camera will be proportionally negatively impacted by the existence of smoke inside the AV. In the latter case, the clarity of the image captured by the camera will be proportionally negatively impacted by the existence of smoke inside the AV. In particular embodiments, the opacity of the air inside the AV may be quantified by comparing the measured luminance value or the captured image to a known baseline luminance value or image. In some embodiments, the baseline information is obtained from the AV itself; in other embodiments, the baseline information is obtained from one or more other AVs in the fleet.

At operation 304, a determination is made whether the event detected at operation 302 is an internal AV thermal event. In particular, to rule out false positive detections, at operation 304, the opacity of the air inside the AV cabin (as determined in operation 302) is compared to the opacity of the air exterior to the AV. In particular embodiments, the opacity of the air exterior to the AV may be determined in a manner similar to that used to make the determination within the AV, using exterior AV sensors in combination with exterior lights having known luminance values (e.g., traffic lights) or by evaluating images captured using exterior AV cameras for sharpness. If the difference between the interior air opacity level and the exterior air opacity level is less than a predetermined threshold value, then it will be assumed that the increased opacity level of the air inside the AV is due to exterior conditions, such as wildfires or air pollution, and not to an internal AV thermal event, and execution returns to operation 300. In contrast, if the difference between the interior and exterior opacity levels is greater than the predetermined threshold value, it will be assumed that the increased opacity level of the air inside the AV is due to an internal AV thermal event and execution proceeds to operation 306.

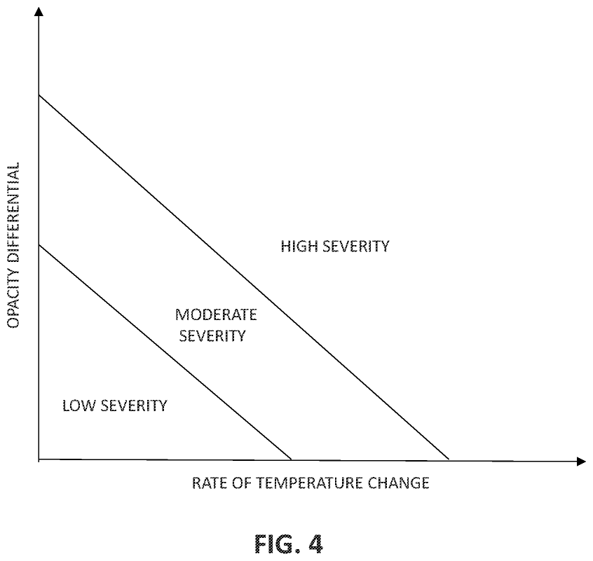

In operation 306, the severity of the internal AV thermal event is determined. This may be accomplished in one or more of a variety of manners. In one embodiment, a machine learning module within the AV compute system may be used to measure the rate of internal temperature change of the AV and the opacity (and/or rate of opacity change) within the interior of the AV to determine the severity of the internal AV thermal event. For example, a low internal temperature/rate of internal temperature change combined with a low internal air opacity/rate of opacity change corresponds to a low severity thermal event. A moderate internal temperature/rate of internal temperature change combined with a moderate internal air opacity/rate of opacity change corresponds to a moderate severity thermal event. A high internal temperature/rate of internal temperature change combined with a high internal air opacity/rate of opacity change corresponds to a high severity thermal event. This concept is illustrated in FIG. 4.

Change in internal temperature of the AV in operation 306 may be measured, or estimated, directly or indirectly using sensors integrated into components of the AV. For example, a duty cycle of the HVAC system of the AV may be used as a surrogate for change in internal temperature. In particular, a continued increase in HVAC duty cycle over a relevant period of time may indicate that the HVAC system is having to work harder to maintain the interior of the vehicle at a selected temperature, presumably due to the internal AV thermal event. Alternatively, data from integrated temperature sensors within various components of the AV, including the HVAC system may be used directly to track a rate of temperature change. Additionally, and/or alternatively, an interior cameras (and more particularly, the light meter thereof) may be used to measure the overall brightness of the interior of the AV, which may be compared to a known baseline to detect a fire within the AV.

At operation 308, the internal AV thermal event is responded to based on the determined severity thereof. For example, if the internal AV thermal event is a low severity event, the windows of the AV may be opened to clear and/or cool the air in the AV. If the internal AV thermal event is a moderate severity event, such as a passenger smoking inside the AV, full blower plus fresh air HVAC operation may be enabled in order to clear the smoke from the cabin and the AV could be connected with a customer advisor who may remind the passenger that the AV is a non-smoking vehicle. If the internal AV thermal event is a high severity event, such as ignition of an object within the cabin, a vehicle behavior, such as a safe stop, may be triggered, with the perception system commanding the AV path planning system to stop the AV and open the doors to ventilate the cabin and to communicate to the back office that a high severity thermal event has been detected. Remote assistance may be provided to confirm the smoke or ignition using internal AV cameras.

Other possible responses, especially to a high severity event, include but are not limited to activating an onboard fire suppression system (either automatically or by prompting a passenger to do so by activating a lever within the AV), routing the AV to a police or fire station before stopping the AV, routing the AV to a fleet service center (e.g., for post event cleaning and/or servicing of the AV) before returning the AV to service, detecting that the AV is in a pedestrian-dense area and routing the AV to a pedestrian-light area before stopping the AV, detecting that the AV is near a flammable object and routing the AV away from the object before stopping the AV, for example.

The type of response initiated may also depend on whether the AV is currently providing a service and if so, the type of service (e.g., passenger transportation or delivery) being provided, and environmental and geographical considerations, such as weather (e.g., rainy, sunny, hot, cold), map location (e.g., urban, rural, highway, non-highway), and time of day, for example.

It will be recognized that, although three severity levels have been described for the sake of example, more or fewer levels may be implemented.

Although the operations of the example method shown in and described with reference to FIG. 3 are illustrated as occurring once each and in a particular order, it will be recognized that the operations may be performed in any suitable order and repeated as desired. Additionally, one or more operations may be performed in parallel. Furthermore, the operations illustrated in FIG. 3 may be combined or may include more or fewer details than described.

### Example Processor-Based System

FIG. 5 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a Bluetooth® wireless signal transfer, a Bluetooth® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more GNSS receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer-readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc ROM (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, RAM, Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network personal computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Example 1 is a method including determining an opacity level of air inside a vehicle using at least one sensor disposed inside a cabin of the vehicle; comparing the determined opacity level with a threshold opacity level, wherein when the determined opacity level exceeds the threshold opacity level, an internal thermal event is deemed to have occurred in connection with the vehicle; determining a severity of the internal thermal event; and initiating a response to the internal thermal event, wherein the response is based on the determined severity of the internal thermal event.
Example 2 provides the method of example 1, further including comparing an opacity level of air outside the vehicle with the determined opacity level of the air inside the vehicle.
Example 3 provides the method of example 2, wherein if the opacity level of the air outside the vehicle is greater than the opacity level of the air inside the vehicle, the severity of the internal thermal event is deemed to be nominal and the response is not initiated.
Example 4 provides the method of example 1, wherein the response is further based on environmental factors associated with a location of the vehicle when the internal thermal event is deemed to have occurred.
Example 5 provides the method of example 1, wherein the response is further based on geographic factors associated with a location of the vehicle when the internal thermal event is deemed to have occurred.
Example 6 provides the method of example 1, wherein the at least one sensor includes a light meter and the determining the opacity of the air inside the vehicle further includes using the light meter to determine a luminance value of a cabin light disposed inside the cabin of the vehicle.
Example 7 provides the method of example 6, wherein the determining the opacity of the air inside the vehicle further includes comparing the luminance value of the cabin light with a baseline luminance value.
Example 8 provides the method of example 1, wherein the at least one sensor includes a camera and the determining the opacity of the air inside the vehicle further includes evaluating a sharpness of an image generated by the camera.
Example 9 provides the method of example 8, wherein the evaluating the sharpness of the image generated by the camera includes comparing the image generated by the camera with a baseline image.

Example 10 provides the method of example 1, wherein the determining the severity of the internal thermal event further includes determining a change in the opacity of the air inside the vehicle over a designated time frame; and determining a change in an interior temperature of the vehicle over the designated time frame.
Example 11 provides the method of example 10, wherein the determining the change in the interior temperature of the vehicle further includes determining a change in a duty cycle of a heating, ventilation, and cooling (HVAC) system of the vehicle over the designated time frame.
Example 12 provides the method of example 1, wherein the at least one sensor includes a light meter and the determining the severity of the internal thermal event further includes using the light meter to determine a luminance value the cabin, wherein if the luminance value of the cabin exceeds a predetermined cabin luminance value, the severity of the internal thermal event is deemed to be high.
Example 13 provides the method of example 1, wherein the response includes at least one of initiating a safe stop of the vehicle, opening a door of the vehicle, opening a window of the vehicle, activating a fire suppression system installed in the vehicle, contacting remote assistance, and controlling a heating, ventilation, and cooling (HVAC) system of the vehicle.
Example 14 provides a method including detecting an event inside an autonomous vehicle (AV) using at least one onboard sensor installed in an interior of the AV; determining whether the detected event includes an internal thermal event in connection with the AV; if the detected event includes an internal thermal event, determining a severity of the internal thermal event; and initiating a response to the internal thermal event based on the determined severity of the internal thermal event.
Example 15 provides the method of example 14, wherein the detecting the event inside the AV includes determining an opacity level of air inside the AV using the at least one onboard sensor.
Example 16 provides the method of example 15, wherein the determining whether the detected event includes an internal thermal event further includes comparing the determined opacity level with a threshold opacity level, wherein if the determined opacity level exceeds the threshold opacity level, the event is deemed to include the internal thermal event.
Example 17 provides the method of example 15, wherein the at least one onboard sensor includes a light meter and the wherein the determining the opacity of the air inside the AV further includes using the light meter to determine a luminance value of a cabin light disposed inside the cabin of the AV; and comparing the luminance value of the cabin light with a baseline luminance value obtained from another AV in a fleet of AVs.
Example 18 provides the method of example 15, wherein the at least one sensor includes a camera and wherein the determining the opacity of the air inside the AV further includes evaluating a sharpness of an image generated by the camera, the evaluating including comparing the image generated by the camera with a baseline image obtained from another AV in a fleet of AVs.
Example 19 provides a non-transitory computer-readable medium having stored thereon instructions that, when executed by a processor of a computer, cause the computer to detect an event inside an autonomous vehicle (AV) using at least one onboard sensor installed in an interior of the vehicle; determine whether the detected event includes an internal thermal event in connection with the vehicle; and, if the detected event includes an internal thermal event, determine a severity of the internal thermal event; and initiate a response to the internal thermal event based on the determined severity of the internal thermal event; wherein the detecting the event inside the AV includes determining an opacity level of air inside the AV using the at least one onboard sensor.
Example 20 provides the non-transitory computer-readable medium of example 19, wherein the determining whether the detected event includes an internal thermal event further includes comparing the determined opacity level with a threshold opacity level, wherein if the determined opacity level exceeds the threshold opacity level, the event is deemed to include the internal thermal event.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the interior electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as exterior storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended examples. The specifications apply only to one non-limiting example and, accordingly, they should be construed as such. In the foregoing description, example embodiments have been described with reference to particular arrangements of components. Various modifications and changes may be made to such embodiments without departing from the scope of the appended examples. The description and drawings are, accordingly, to be regarded in an illustrative rather than in a restrictive sense.

Note that with the numerous examples provided herein, interaction may be described in terms of two, three, four, or more components; however, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Various operations may be described as multiple discrete actions or operations in turn in a manner that is most helpful in understanding the example subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended examples. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the examples appended hereto, Applicant wishes to note that the Applicant: (a) does not intend any of the appended examples to invoke paragraph (f) of 35 U.S.C. Section 112 as it exists on the date of the filing hereof unless the words “means for” or “step for” are specifically used in the particular examples; and (b) does not intend, by any statement in the Specification, to limit this disclosure in any way that is not otherwise reflected in the appended examples.

What is claimed is:

1. A method comprising:
determining an opacity level of air inside a vehicle using at least one sensor disposed inside a cabin of the vehicle;
comparing the determined opacity level with a threshold opacity level, wherein when the determined opacity level exceeds the threshold opacity level, an internal thermal event is deemed to have occurred in connection with the vehicle;
determining a severity of the internal thermal event; and
initiating a response to the internal thermal event, wherein the response is based on the determined severity of the internal thermal event.

2. The method of claim 1, further comprising comparing an opacity level of air outside the vehicle with the determined opacity level of the air inside the vehicle.

3. The method of claim 2, wherein if the opacity level of the air outside the vehicle is greater than the opacity level of the air inside the vehicle, the severity of the internal thermal event is deemed to be nominal and the response is not initiated.

4. The method of claim 1, wherein the response is further based on environmental factors associated with a location of the vehicle when the internal thermal event is deemed to have occurred.

5. The method of claim 1, wherein the response is further based on geographic factors associated with a location of the vehicle when the internal thermal event is deemed to have occurred.

6. The method of claim 1, wherein the at least one sensor comprises a light meter and the determining the opacity of the air inside the vehicle further comprises using the light meter to determine a luminance value of a cabin light disposed inside the cabin of the vehicle.

7. The method of claim 6, wherein the determining the opacity of the air inside the vehicle further comprises comparing the luminance value of the cabin light with a baseline luminance value.

8. The method of claim 1, wherein the at least one sensor comprises a camera and the determining the opacity of the air inside the vehicle further comprises evaluating a sharpness of an image generated by the camera.

9. The method of claim 8, wherein the evaluating the sharpness of the image generated by the camera comprises comparing the image generated by the camera with a baseline image.

10. The method of claim 1, wherein the determining the severity of the internal thermal event further comprises:
determining a change in the opacity of the air inside the vehicle over a designated time frame; and
determining a change in an interior temperature of the vehicle over the designated time frame.

11. The method of claim 10, wherein the determining the change in the interior temperature of the vehicle further comprises determining a change in a duty cycle of a heating, ventilation, and cooling (HVAC) system of the vehicle over the designated time frame.

12. The method of claim 1, wherein the at least one sensor comprises a light meter and the determining the severity of the internal thermal event further comprises using the light meter to determine a luminance value the cabin, wherein if the luminance value of the cabin exceeds a predetermined cabin luminance value, the severity of the internal thermal event is deemed to be high.

13. The method of claim 1, wherein the response comprises at least one of initiating a safe stop of the vehicle, opening a door of the vehicle, opening a window of the vehicle, activating a fire suppression system installed in the vehicle, contacting remote assistance, and controlling a heating, ventilation, and cooling (HVAC) system of the vehicle.

14. A method comprising:
detecting an event inside an autonomous vehicle (AV) using at least one onboard sensor installed in an interior of the AV;
determining whether the detected event comprises an internal thermal event in connection with the AV;
if the detected event comprises an internal thermal event:
determining a severity of the internal thermal event; and
initiating a response to the internal thermal event based on the determined severity of the internal thermal event.

15. The method of claim 14, wherein the detecting the event inside the AV comprises determining an opacity level of air inside the AV using the at least one onboard sensor.

16. The method of claim 15, wherein the determining whether the detected event comprises an internal thermal event further comprises comparing the determined opacity level with a threshold opacity level, wherein if the determined opacity level exceeds the threshold opacity level, the event is deemed to comprise the internal thermal event.

17. The method of claim 15, wherein the at least one onboard sensor comprises a light meter and the wherein the determining the opacity of the air inside the AV further comprises:
using the light meter to determine a luminance value of a cabin light disposed inside the cabin of the AV; and
comparing the luminance value of the cabin light with a baseline luminance value obtained from another AV in a fleet of AVs.

18. The method of claim 15, wherein the at least one sensor comprises a camera and wherein the determining the opacity of the air inside the AV further comprises evaluating a sharpness of an image generated by the camera, the evaluating comprising comparing the image generated by the camera with a baseline image obtained from another AV in a fleet of AVs.

19. A non-transitory computer-readable medium having stored thereon instructions that, when executed by a processor of a computer, cause the computer to:
detect an event inside an autonomous vehicle (AV) using at least one onboard sensor installed in an interior of the vehicle;
determine whether the detected event comprises an internal thermal event in connection with the vehicle; and
if the detected event comprises an internal thermal event:
determine a severity of the internal thermal event; and
initiate a response to the internal thermal event based on the determined severity of the internal thermal event;
wherein the detecting the event inside the AV comprises determining an opacity level of air inside the AV using the at least one onboard sensor.

20. The non-transitory computer-readable medium of claim 19, wherein the determining whether the detected event comprises an internal thermal event further comprises comparing the determined opacity level with a threshold opacity level, wherein if the determined opacity level exceeds the threshold opacity level, the event is deemed to comprise the internal thermal event.
